(19) United States
(12) Patent Application Publication
(10) Pub. No.: US 2025/0292680 A1
(43) Pub. Date: Sep. 18, 2025

(54) SYSTEMS AND METHODS FOR ENHANCING CONTROL OF VEHICLES USING A DRONE

(71) Applicant: Honda Motor Co., Ltd., Tokyo (JP)

(72) Inventor: Tyler Robert Naes, Farmington, MI (US)

(21) Appl. No.: 18/606,885

(22) Filed: Mar. 15, 2024

(51) Int. Cl. G08G 1/0968; B64U 10/60; B64U 50/37; B64U 70/93; B64U 101/00; G01C 21/00; G08G 1/01; G08G 1/04; G08G 1/0967

(52) U.S. Cl. CPC G08G 1/096811; B64U 10/60; B64U 50/37; B64U 70/93; G01C 21/3837; G08G 1/012; G08G 1/0133; G08G 1/04; G08G 1/096725; B64U 2101/00

(57) ABSTRACT

A vehicle including an integrated advanced driver-assistance system (ADAS) vehicle controller, a plurality of sensors, and a drone is provided. The vehicle controller includes a memory configured to store program instructions, and a processor configured to execute the program instructions. The plurality of sensors include at least a first sensor configured to transmit data to the vehicle controller. The drone is removably coupled to the vehicle. The drone includes at least a second sensor configured to transmit data to the processor. The vehicle controller is programmed to determine whether to launch the drone from the vehicle when the vehicle approaches a pre-defined operating environment, and to selectively change operation of the vehicle at least partially based on data received from the drone.

### FIELD OF THE INVENTION

The present disclosure relates to vehicular control and navigation and, more particularly, to systems and methods for enhancing control of vehicles in potential traffic dense environments.

### BACKGROUND

Automated and semi-automated vehicles have become more widespread necessitating improvements in the accuracy and speed in which one or more automatic controls are determined and executed by the vehicle. High dense traffic environments, such as may occur with inter-city driving, presents challenges when determining real-time controls for automated and semi-automated vehicles. Furthermore, traffic intersections, such as merge lanes and round-abouts, may create potentially hazardous and/or collision-prone conditions as multiple vehicles may converge and approach the intersection from different directions. Accordingly, precise vehicle controls need to be determined quickly and efficiently to facilitate enhancing the safety and reliability of the automated and semi-automated vehicle navigation within such traffic scenarios.

Known traffic intersections have a wide range of configurations. For example, known intersections may include traffic lights, or stop/yield signs used to control the flow of traffic from a plurality of merging roads that each have a varying number of lanes, which may include dedicated turn lanes and that each merge into the intersection from its own direction and at its own angle relative to the intersection. Determined vehicle controls must be suitable for the vehicle to perform at the specific configuration of the traffic intersection. For example, each intersection configuration may include multiple available routes, and/or traffic restrictions that the vehicle must comply with as the automated and semi-automated vehicle traverses the intersection.

Generally, to facilitate optimizing the control of the automated and semi-automated vehicles, at least some known vehicles include an air-ground integrated automatic driving system that communicates with an unmanned aerial vehicle, i.e., a drone. The drone acquires information related to a vicinity of the automated or semi-automated vehicle using sensors that capture image data. The vehicle transmits the data to a remote server that generates a map based on the received images. After the map is transmitted to the vehicle, navigation conditions may be determined based on the generated map. However, the use of such technology may be limited based on the accuracy of the map modeling system and the timing of generating the map. Moreover, such technology may be limited based on the flight duration limitations of the battery-powered drone, as the same batteries that power the flight of the drone are also used to power the image data equipment and the communications equipment on the drone.

Accordingly, it is desirable to have systems and methods that can enhance vehicle controls, in a manner that facilitates generating optimal and/or more efficient vehicle travel path routes through traffic dense environments, while simultaneously improving the computational efficiency and speed at which these vehicle controls are determined.

### BRIEF SUMMARY

In one aspect, a vehicle including an integrated advanced driver-assistance system (ADAS) vehicle controller, a plurality of sensors, and a drone is provided. The vehicle controller includes a memory configured to store program instructions, and a processor configured to execute the program instructions. The plurality of sensors include at least a first sensor configured to transmit data to the vehicle controller. The drone is removably coupled to the vehicle with at least a tether. The drone includes at least a second sensor configured to transmit data to the processor. The vehicle controller is programmed to determine whether to launch the drone from the vehicle when the vehicle approaches a pre-defined operating environment, and to selectively change operation of the vehicle based on data received from the drone.

In another aspect, a control system for controlling a vehicle is provided. The control system includes a computer device integrated with a vehicle advanced driver-assistance system (ADAS) for the vehicle. The computer device comprises at least one memory, and at least one processor in communication with the at least one memory. The at least one processor is programmed to collect LIDAR data from at least one drone coupled against the vehicle during operation of the vehicle, to collect LIDAR data from the at least one drone while the drone is airborne and tethered to the vehicle, and to determine at least one course of action for the vehicle to execute, based on the LIDAR data received.

In a further aspect, a method for controlling a vehicle using a vehicle controller associated with the vehicle is provided. The method includes collecting first sensor information from at least a first sensor during operation of the vehicle, wherein the first sensor is coupled to the vehicle, and determining an operating environment of the vehicle based the first sensor information. The method also includes determining whether to launch the drone from the vehicle based on the first sensor information, collecting second sensor data from a drone tethered to the vehicle when the drone is one of coupled against the vehicle and is airborne while tethered to the vehicle, generating a real-time map based on the collected second sensor data.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an exemplary embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a schematic diagram of an exemplary vehicle including a vehicle controller integrated with a vehicle advanced driver-assistance system (ADAS) for the vehicle.

FIG. 2 illustrates a schematic diagram of the vehicle shown in FIG. 1 traveling within a potential traffic dense environment that could trigger a launch of the drone.

FIG. 3 illustrates a schematic diagram of an on-ramp/merge lane that could trigger a launch of the drone.

FIG. 4 illustrates a schematic diagram of an intersection that could trigger a launch of the drone.

FIG. 5 illustrates a schematic diagram of another intersection that could trigger a launch of the drone.

FIG. 6 illustrates a schematic diagram of the vehicle shown in FIG. 1 executing a maneuver that could trigger a launch of the drone.

FIG. 7a is a schematic diagram of the vehicle shown in FIG. 1 that has not launched a drone and that is traveling within a potential triggering designation environment.

FIG. 7b is a schematic diagram of the vehicle shown in FIG. 7a and with the drone launched from the vehicle.

FIG. 8 is a schematic diagram of the vehicle shown in FIG. 1 in another environment in which the drone has launched.

FIG. 9 illustrates a flowchart of an exemplary process that may be implemented to determine one or more courses of action for the vehicle shown in FIG. 1 to perform when approaching a traffic dense environment.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

A computer program of one embodiment is embodied on a computer-readable medium. In an example, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in different environments without compromising any major functionality. In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

As used herein, the terms “processor” and “computer” and related terms, e.g., “processing device,” “computer device,” and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of: the time of occurrence of the associated events, the time of measurement and collection of predetermined data, the time for a computer device (e.g., a processor) to process the data, and/or the time of a system response to the events and the environment. In the embodiments described herein, these activities and events may be considered to occur substantially instantaneously.

The present embodiments may relate to, inter alia, systems and methods that may be implemented to control a vehicle travelling through an intersection based upon sensor data received in real-time. In an exemplary embodiment, the process is performed by a vehicle control system, also known as a vehicle controller.

In the exemplary embodiment, the vehicle includes a plurality of sensors that enable the vehicle to observe its surroundings in real-time. The sensors can include, but are not limited to only including, radar, LIDAR, proximity sensors, ultrasonic sensors, electromagnetic sensors, wide RADAR, long distance RADAR, Global Positioning System (GPS), video devices, imaging devices, cameras, audio recorders, and computer vision. The vehicle controller receives sensor data from the sensors.

In one embodiment, based on the information from the sensors, the vehicle controller determines that the vehicle is approaching a pre-defined triggering environment or area, such as, but not limited to a traffic dense environment. As the vehicle approaches the triggering area, the vehicle controller performs one or more processes to determine and/or identify the type of the triggering event. Subsequently, after the type of triggering event has been identified, the controller causes a drone tethered to the vehicle to launch to enable the area to be scanned from an airborne location. Based on sensor data received from the drone, the controller determines one or more courses of action for the vehicle to perform at, within, and/or near, the approaching triggering area.

A pre-defined triggering designation area includes any designated area or areas that are potential traffic dense areas and/or any area that may or should create a triggering event causing the drone to launch from the vehicle. For example, triggering designation areas may be a type of intersection that the vehicle is approaching, and the type of intersection may be based on the number of roads that merge at the intersection and/or the angle at which the roads merge relative to each other. Triggering designation areas may also be based on the number of lanes of traffic and a number or volume of vehicles within those lanes, and/or whether designated turning lanes are available. Additional triggering designation areas may arise as the vehicle approaches an on-ramp, approaches three-or four-way intersections, and/or approaches a round-about intersection. Further triggering events may occur as the controller determines that the vehicle should enter the on-going traffic lane to pass another vehicle traveling in the same direction. Additional triggering designation areas may occur when the vehicle enters a parking lot, and/or is passing a plurality of vehicles stopped and/or parked adjacent to a parallel-oriented sidewalk, for example. Various intersection types and associated triggering designation areas are described in detail below.

In one embodiment, the vehicle controller utilizes at least two process models to determine a course of action for the vehicle. In some embodiments, the vehicle controller executes an algorithm to determine whether to launch the drone airborne, and/or which if any course of action should be taken for the vehicle. For example, in the exemplary embodiment, a first process model includes a triggering classification (TC) model that is used to determine the type of triggering event, and a second model includes an environment specific(ES) model that is used to determine one or more courses of action for the vehicle to perform. In some embodiments, the vehicle controller may include a single TC model and a plurality of ES models. Each of the ES models is associated with a specific type or category of triggering designation areas or environments.

In one embodiment, one or more TC model inputs may be applied to the TC model to determine one or more TC model outputs. Likewise, one or more ES model inputs may be applied to the ES model to determine one or more ES model outputs. The TC model outputs include a determined triggering environment type. The ES model outputs include one or more courses of action for the vehicle to perform while entering, or while within, the triggering designation area. The TC model inputs and the ES model inputs may include sensor data collected from one or more of the sensors. The one or more of the TC model inputs may be the same as one or more of the ES model inputs. In some embodiments, one or more of the TC model inputs and the ES model inputs may be different. In some embodiments, the TC model inputs are less than, and/or a subset of the ES model inputs.

In some embodiments, the TC model inputs may include image data collected from sensors, such as video devices, imaging devices, and/or a camera. In other embodiments, the TC model inputs may include additional and/or alternative inputs. In some embodiments, the ES model inputs may include data collected from sensors, such as radar, LIDAR, proximity sensors, ultrasonic sensors, electromagnetic sensors, wide RADAR, long distance RADAR, Global Positioning System (GPS), video devices, imaging devices, cameras, audio recorders, and computer vision.

In the exemplary embodiment, the vehicle controller, initially, determines a type of triggering designation area of an approaching environment, using the TC model, then subsequently, after the intersection type is determined, the vehicle controller determines one or more vehicle courses of action for the vehicle to perform using the IS model corresponding to the previously identified type of triggering designation area. In other words, the vehicle controller applies TC model inputs to the TC model initially to determine the type of triggering designation area. After the type of triggering event is identified, the vehicle controller may launch the drone and retrieve, e.g., from a database and/or a memory, an ES model associated with the identified triggering area. The vehicle controller then applies the ES inputs to the ES model to determine one or more courses of action for the vehicle to perform while approaching and/or within the triggering area.

In some embodiments, vehicle courses of action may include at least one of the following actions: steering, accelerating, maintaining a speed, and/or decelerating. In some embodiments, the course of action may include an intersection path, such as an optimal path or a safe path for the vehicle to follow through an intersection. The courses of action may also include steering the vehicle to follow the intersection path through the intersection or in proximity to the intersection. The determined vehicle course of action may include additional and/or alternative courses of action. In some embodiments, the ES model and/or the vehicle controller uses a destination of the vehicle to determine the one or more courses of action for the vehicle. The destination may be a target location of the vehicle, requiring the vehicle to traverse one or more intersections along the way towards the destination. For example, the ES model and/or the vehicle controller may incorporate the destination when determining the one or more courses of action, and/or the intersection path, for the vehicle to perform.

The ES model and/or the vehicle controller may also incorporate the detection of obstacles, e.g., other vehicles and/or objects, when determining the courses of action for the vehicle. In some cases, the ES model and/or the vehicle controller may determine one or more maneuvering controls to avoid obstacles in the triggering designation and/or to avoid obstacles in the determined intersection path.

In some embodiments, the TC model inputs may be collected prior to the collection of ES model inputs. Alternatively, the TC model inputs and the ES model inputs may be collected substantially simultaneously. In some embodiments, the vehicle controller may collect TC model inputs, apply the TC model inputs to the TC model, and determine a type of triggering designation area, concurrently while continuously collecting the ES model inputs.

In some embodiments, the vehicle controller may determine a type of triggering designation area without applying the TC model. For example, in some embodiments, the type of triggering designation area may have been previously identified and/or the type intersection may be obtained, and as such it is unnecessary to apply the TC model. In some embodiments, the type of triggering designation environment may have been previously identified by the vehicle controller, and the vehicle controller stored the identified triggering designation area in a memory and/or a database for subsequent retrieval. In some embodiments, the vehicle controller may be communicatively coupled to a location sensor, e.g., Global Positioning System (GPS) sensor, such that the vehicle controller may determine the location of the vehicle. The vehicle controller may use the location of the vehicle to determine a type of triggering designation area. For example, in some embodiments, the vehicle controller may receive and/or retrieve an intersection type from other sources, e.g., a map source (e.g., Google maps). Accordingly, in some embodiments, it may be unnecessary to execute the TC model, and the vehicle controller may directly apply the ES model associated with the previously determined type of triggering designation area to determine one or more courses of action.

The vehicle controller may generate, e.g., train, tune, and/or update, the TC model using historic intersection data. The historic data may include a plurality of images and/or videos of triggering areas and an associated identification of the type of triggering designation area. The historic data may include a plurality of intersection records, for example. In such an exemplary embodiment, each intersection record may include: i) an identified intersection type of the historic intersection, ii) one or more designations that describe the configuration of the historic intersection, and iii) any sensor data previously transmitted of the historic intersection (e.g., images and/or video of the intersection taken from various vantage points and/or a street view of the intersection).

In some embodiments, each of the ES models are associated with a specific type of triggering designation environment, and each of the ES models are generated, e.g., trained, tuned and/or updated, using a dataset that includes relevant, and/or focused, data pertinent to the type of triggering designation area in the ES model. For example, each individual ES model may be generated using a specific historic dataset associated with the specific type of triggering designation area in the ES model. Generating the ES model using a reduced size and with a more focused training dataset facilitates improving the computational efficiency during generation and/or updating of the ES model. For example, training of the ES model using the reduced and focused dataset is generally faster and requires less computational resources, e.g., less memory, and/or improved processor efficiency (e.g., CPU efficiency). Furthermore, applying the ES model, trained using the focused and reduced size dataset, enables courses of actions suitable for the type of triggering designation area to be determined quickly, reliably, and efficiently.

In some embodiments, the ES model may be generated, e.g., trained, tuned, and/or updated, using one or more allowable courses of action and/or one or more prevented and/or restricted courses of action. The allowable, prevented, and/or restricted courses of action may be associated with the particular type and/or designation of the intersection. For example, for an intersection type having a T-shape, the vehicle controller determines courses of actions that are limited to turning onto one of the two available roads. In another example, a type of triggering area may include designated turn lanes, and the vehicle controller may determine, if the vehicle is going to make a left turn, that the vehicle is required to enter and use the left turn lane.

In some embodiments, the ES model may have one or more model outputs including a right-of-way determination. That is, one course of action for the vehicle may include determining a right-of-way between multiple vehicles approaching the intersection and arriving at substantially the same time. For example, one model output may include a course of action for the vehicle based on the determined right-of-way. In another example, a model output may include determining that the vehicle does not have a right-of-way and determining one or more braking or yielding operations to be performed by the vehicle. In another example, a model output may include determining that the vehicle has a right-of-way and determining a speed or accelerating operation to be performed by the vehicle.

In some embodiments, a user/driver may store preferences that would let the vehicle controller know if there are any extra considerations in its decision-making process. The vehicle controller may use these preferences as weighting in its decision-making process. In some embodiments, the user may directly enter their preferences. For example, the user/driver may want to minimize left turns across a lane designated for an opposite flow of traffic. In other embodiments, the vehicle controller learns these preferences over time based on the user's driving behavior. Other preferences may include regional or national preferences based on observations of the vehicle controller and/or a plurality of vehicle controllers.

At least one of the technical problems addressed by this system may include: (i) improving the determination of one or more courses of vehicle actions for the vehicle to perform at, and/or in proximity to, one or more identified types of triggering designation areas, (ii) improving the computational efficiency, e.g., decreased computational times and/or reduced computational load, when determining one or more courses of action for the vehicle to perform at, and/or in proximity to, one or more identified types of triggering designation environments, (iii) identification and/or classification of a plurality of types of triggering designation areas; (iv) identification and/or classification of a type of triggering designation environment using images; and/or (v) providing specific vehicle courses of action based on the identification of the type of triggering designation environment.

The methods and systems described herein may be implemented using computer programming or engineering techniques including computer software, firmware, hardware, or any combination or subset thereof, wherein the technical effects may be achieved by performing at least one of the following steps: a) collect a first plurality of sensor information observed/sensed by at least a first sensor during operation of a vehicle; b) collect a second plurality of sensor information observed/sensed by at least a second sensor during operation of a vehicle; c) execute a first classification model to determine a type of triggering designation area; and d) after the type of triggering designation environment has been determined, launching a tethered drone to enable executing a specific model associated with the identified triggering designation area to determine one or more vehicle courses of action for the vehicle to perform at the determined type of triggering designation environment.

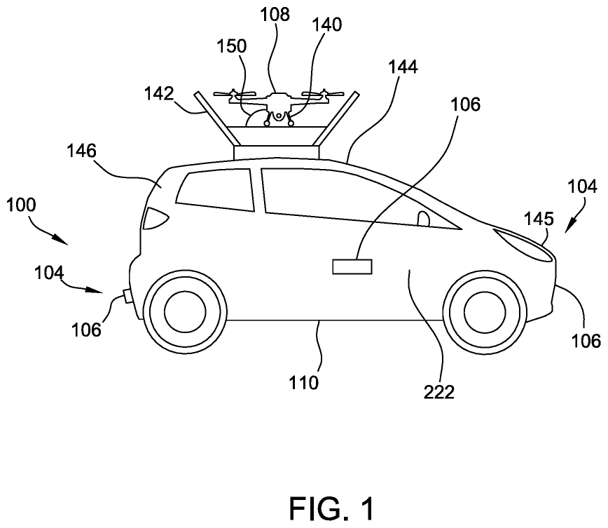

FIG. 1 depicts a view of an exemplary vehicle 100. In some embodiments, vehicle 100 may be an autonomous or semi-autonomous vehicle capable of fulfilling the transportation capabilities of a traditional automobile or other vehicle. In these embodiments, vehicle 100 may be capable of sensing its environment and/or navigating through traffic intersections and traffic without human input. In other embodiments, vehicle 100 is a manually-driven vehicle or a semi-autonomous vehicle that includes driver assistance systems, such as, but not limited to, lane-keep assistance, and/or parallel-parking assistance, wherein the vehicle may be driven as a traditional automobile that is controlled by a driver (not shown).

Vehicle 100 may include a plurality of sensors 104 and a vehicle controller 110. The sensors 104 may detect the current surroundings/environment and location of vehicle 100. The sensors 104 may include, but are not limited to only including, radar, LIDAR, proximity sensors, ultrasonic sensors, electromagnetic sensors, wide RADAR, long distance RADAR, Global Positioning System (GPS), video devices, imaging devices, cameras, audio recorders, and computer vision. The sensors 104 may also detect operating conditions of vehicle 100, such as speed, acceleration, gear, braking, and/or other conditions related to the operation of vehicle 100, for example: at least one of a measurement of the speed, direction, rate of acceleration, rate of deceleration, location, position, orientation, and/or rotation of the vehicle, and a measurement of one or more changes to the speed, direction rate of acceleration, rate of deceleration, location, position, orientation, and/or rotation of the vehicle. Furthermore, sensors 104 may include impact sensors that detect impacts to vehicle 100, including the force and direction, and/or the deployment of airbags. In some embodiments, sensors 104 may detect the presence of a driver and/or one or more passengers (not shown) in vehicle 100. In such embodiments, sensors 104 may detect the presence of fastened seatbelts, the weight occupying each seat in vehicle 100, heat signatures, and/or any other method of detecting information about the driver and/or passengers in vehicle 100.

In some embodiments, the sensors 104 may determine weight distribution information of vehicle 100. Weight distribution information may include, but is not limited to only including, the weight and location of remaining gas, luggage, occupants, and/or other components of vehicle 100. In some embodiments, sensors 104 may determine remaining gas, luggage weight, occupant body weight, and/or any other weight distribution information. Furthermore, the sensors 104 may detect attachments to the vehicle 100, such as cargo carriers or bicycle racks attached to the top of the vehicle 100 and/or a trailer attached to a hitch on the rear of the vehicle 100, for example.

In some embodiments, the sensors 104 include cameras, LIDAR, radar, proximity detectors, and/or other sensors 104 that provide information about the surroundings of the vehicle 100, such as, but not limited to, other vehicles including the vehicle type and the vehicle load, obstacles, traffic flow information including road signs, traffic lights, and other traffic information, and/or other environmental information, including current weather conditions.

In some embodiments, the sensors 104 may include a plurality of first sensors 106 mounted or coupled to the vehicle 100, and one or more second sensors 108 coupled to a drone 140 tethered to the vehicle 100. The first sensors 106 collect images and/or videos, e.g., the first sensors 106 may include a video and/or a camera, and the second sensors 108 may include those type of sensors and/or any other type of sensor.

Vehicle controller 110 may interpret the sensory information, obtained from sensors 104, to identify appropriate navigation paths through intersections, to detect threats, and/or to react to conditions. In some embodiments, vehicle controller 110 may be able to communicate with one or more remote computer devices, such as a mobile device. In the example embodiment, the mobile device is associated with a driver and includes one or more internal sensors, such as an accelerometer, a gyroscope, and/or a compass. The mobile device may be capable of communicating with vehicle controller 110 wirelessly. In addition, vehicle controller 110 and the mobile device may be configured to communicate with computer devices located remotely from vehicle 100.

The vehicle controller 110 may receive user preferences from the user through the mobile device or through an infotainment panel (not shown). The vehicle controller 110 may also receive preferences via one or more remote servers. These remote servers may be associated with the vehicle manufacturer or other service provider that provides preference information. The remote servers may also provide traffic information including, but not limited to, travel routes, maps, traffic light timing, and/or current traffic load in areas in proximity to the vehicle 100.

In the exemplary embodiment, the vehicle controller 110 is an integrated advanced driver-assistance system (ADAS) that in some embodiments, includes autonomous or semi-autonomous vehicle-related functionality or technology that may be used to replace human driver actions. Such actions may include, but are not limited to only including, and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (l) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; and/or(s) automatic or semi-automatic driving without occupants; and/or other functionality. In these embodiments, the autonomous or semi-autonomous vehicle-related functionality or technology may be controlled, operated, and/or in communication with vehicle controller 110.

The wireless communication-based autonomous or semi-autonomous vehicle technology or functionality may also include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally, or alternatively, the autonomous or semi-autonomous technology or functionality may also include and/or be related to: driver alertness or responsive monitoring; pedestrian detection; artificial intelligence and/or back-up systems; hazard avoidance; navigation or GPS-related systems; security and/or anti-hacking measures; and/or theft prevention systems.

While vehicle 100 may be an automobile in the exemplary embodiment, in other embodiments, vehicle 100 may be, but is not limited to, other types of ground craft including buses, cargo-carriers, or trucks, aircraft, watercraft, and/or spacecraft vehicles.

In the exemplary embodiment, vehicle 100 includes the vehicle-based drone 140. The drone 140 may be any battery-powered, unmanned aircraft or uncrewed aircraft (UA) which is an aircraft without a human pilot on board. The UA 140 may include a remotely piloted aircraft (RPA), a remotely piloted aircraft system (RPAS), an unmanned aerial vehicle or an uncrewed aerial vehicle (UAV), an unmanned aircraft system (UAS), or the like. The drone 140 that may be employed with the vehicle 100 is not particularly limited. For example, the drone 140 may be for a recreational purpose, a commercial purpose, a military purpose, or the like. The drone 140 may include a rotary wing type, a fixed wing type, or a hybrid thereof. The drone 140 may also have a capability to be piloted autonomously while remaining tethered to the vehicle 100.

The vehicle 100 includes a landing dock 142 to provide a platform for the drone 140 to land. In the exemplary embodiment, the landing dock 142 is coupled to a roof 144 of the vehicle. In other embodiments, the landing dock 142 may be coupled to any other location on the vehicle 100, such as, but not limited, to a vehicle hood 145, a vehicle trunk lid 146, and/or to a bed (not shown) of a truck (not shown), for example. In other embodiments, the drone 140 may be mounted on a towed trailer and/or to a separate compartment provided on the vehicle 100. In the exemplary embodiment, the vehicle 100 includes only one drone 140. In other embodiments, the vehicle can include more than one drone 140 and more than one landing dock 142.

The landing dock 142 and/or the drone 140 are coupled to the vehicle controller 110. As such, in the exemplary embodiment, the landing dock 142 not only provides a platform for the drone 140 to land, but also enables the controller 110 to control operation of the drone 140 such as determining when to launch the drone 140, as described in more detail below, and/or charging the batteries (not shown) used to power the drone 140. Furthermore, the landing dock 142 securely couples the drone 140 to the vehicle 100 in an anchored state until the vehicle controller 110 determines the drone 140 should be launched airborne. In some embodiments, the landing dock 142 includes an electro-magnetic coupler (not shown) that facilitates securing the drone 140 to the landing dock 142 and that assists in landing and aligning the drone 140 within the dock 142. In other embodiments, the landing dock 142 includes a coupler (not shown) that mechanically captures the drone 140 during landing and that secures the drone 140 within the dock 142 until it the drone 140 is launched again. In some embodiments, the landing dock 142 includes a platform (not shown) that is variably positionable by the controller 110 to facilitate landing the drone 140 at different angles relative to the vehicle 100, such as may occur if the vehicle 100 is traveling on a banked or sloped roadway for example. In such an embodiment, the landing dock 142 may include a sensor, such as a gyroscope, which facilitates adjustments of the position of the landing dock 142.

In the exemplary embodiment, the drone sensors 108 continuously monitor the road ahead of the vehicle 100 as well as the environment surrounding the vehicle 100. More specifically, the drone sensors 108 include any sensor able to detect objects at a distance. For example, in the exemplary embodiment, sensors 108 include a LIDAR or RADAR sensor or any other sensor capable of collecting data used to generate a 3D map in real-time. In the exemplary embodiment, the drone 140 includes at least one LIDAR sensor 108 that continuously transmits data relating the environment the vehicle 100 is traveling through to the vehicle controller 110. The vehicle controller 110 collects the data transmitted by the drone 140 and because the processing is done at the vehicle 100, the controller 110 generates a three-dimensional (3D) map of the environment in real-time. The primary LIDAR sensor 108 for the drone 140 supplies the data to the vehicle controller 110 not only while securely attached to the landing dock 142, but also continuously when launched from the vehicle 100, whether the vehicle is stationary or is in motion and traveling.

Accordingly, when the drone 140 is docked and in an anchored state, the vehicle controller 110 continuously receives data from the plurality of sensors 106 coupled to the vehicle 100, including data relating to the current surroundings and location of vehicle 100. More specifically, the plurality of sensors 106 may include, but are not limited to only including, proximity sensors, ultrasonic sensors, infra-red sensors, electromagnetic sensors, wide RADAR, long distance RADAR, Global Positioning System (GPS), video devices, imaging devices, cameras, audio recorders, and computer vision. The sensors 106 may also detect operating conditions of vehicle 100, such as speed, acceleration, gear, braking, and/or other conditions related to the operation of vehicle 100, for example: at least one of a measurement of the speed, direction, rate of acceleration, rate of deceleration, location, position, orientation, and/or rotation of the vehicle, and a measurement of one or more changes to the speed, direction rate of acceleration, rate of deceleration, location, position, orientation, and/or rotation of the vehicle. Furthermore, while the drone 140 is securely anchored to the landing dock 142, the vehicle controller 110 also continuously receives LIDAR data from the sensors 108 physically coupled to the drone 140. Similarly, when the drone 140 is launched and is airborne, as described in more detail below, the vehicle controller 110 also continuously receives data from the plurality of sensors 106 coupled to the vehicle 100, as well as from sensors 108 physically coupled to the drone 140, including LIDAR data.

In the exemplary embodiment, the drone 140 is launched from the vehicle 100, as described in more detail below, when the controller 110 determines the vehicle 100 is approaching a situation where information obtained from the drone 140 in flight, i.e., a birds-eye view, would likely be more beneficial than information obtained from the drone 140 when it is at vehicle height, i.e., the drone is physically coupled to the vehicle 100. Moreover, in the exemplary embodiment, the controller 110 initially determines that the drones' s batteries have sufficient charge to support flight of the drone 140. In other words, in the exemplary embodiment, when the controller 110 determines that information obtained from the drone 140 when it is anchored to the landing dock 142 is sufficient, the controller 110 causes the batteries on the drone 140 to be charged. In contrast, when the vehicle controller 110 determines that information from a higher perspective could be more beneficial, the controller 110 causes the drone 140 to be launched from the vehicle 100 after the charge on the drone batteries has been verified.

In an alternative embodiment, the drone 140 remains physically coupled to the vehicle 100, even while airborne, via a tether 150. In the exemplary embodiment, the tether 150 extends outwardly from a reel (not shown) that is coupled to the controller 110. In the alternative embodiment, the tether 150 not only securely couples the drone 140 to the vehicle 100, but also provides a hard-wire connection between the drone 140 and the controller 110. Although the drone 140 includes a plurality of sensors 108 that wirelessly communicate with the controller 110, in the alternative embodiment, the tether 150 provides a redundant means of communication between the drone 140 and the controller 110.

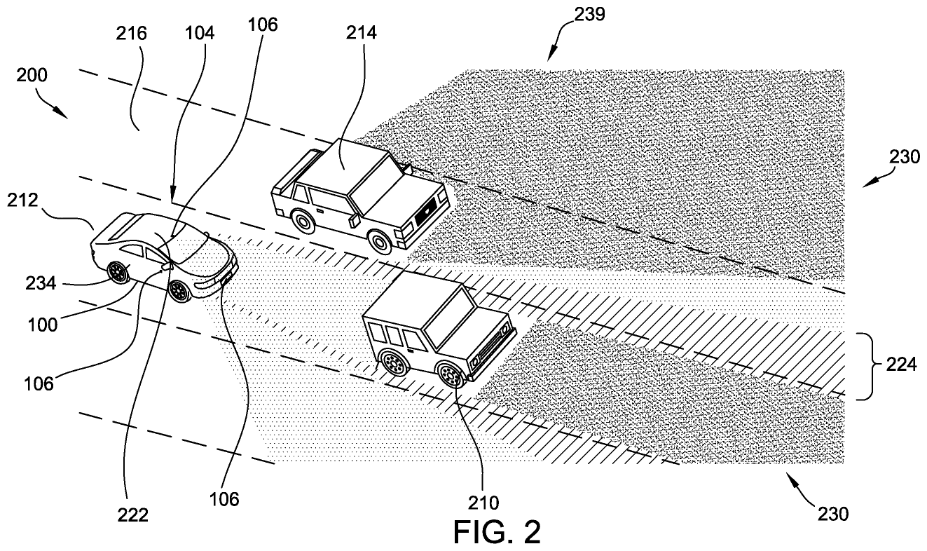

FIGS. 2-8 each illustrate a schematic diagram of vehicle 100 traveling within a potential traffic dense environment or situation 200 that could trigger a launch of the drone 140 as described in more detail below. More specifically, FIG. 2 illustrates the vehicle 100 traveling in a multi-lane 202 roadway, such as an interstate highway, that includes a traffic dense environment 200 that is in close proximity to the vehicle 100. In the illustrated embodiment, the vehicle 100 is traveling behind a first vehicle 210 that is traveling in the same traffic lane 212 and in the same direction as vehicle 100. A second vehicle 214 is also traveling in the same direction as vehicle 100, but is traveling in a traffic lane 216 that is adjacent to lane 212. In such an environment, because the drone 140 is secured to the vehicle loading dock 142, the sensors 104 on the vehicle 100 can provide only limited data to the vehicle controller 110. For example, although the sensors 104 can recognize that vehicles 210 and 214 are present and are traveling in the same direction as vehicle 100, the vehicle sensors 104 are not capable of collecting data from 360° and a few imperceptible areas 230 (i.e., blind-spots) exist relative to vehicle 100.

For example, although a forward-facing camera sensor (not shown) is capable of detecting immediately in-front of vehicle 100 during travel of vehicle 100, the range of detection 220 for that sensor is obstructed by vehicle 210 and by vehicle 214. Moreover, in the exemplary embodiment, the vehicle 100 also includes a pair of side-view mirror camera sensors (not shown) that face generally forwardly from the side mirrors 222 on the vehicle 100. However, the typical conical-shaped range of detection 224 of each mirror camera sensor is obstructed by vehicle 210 and potentially by vehicle 214. Accordingly, an imperceptible area 230 is created immediately in front of vehicle 210. Moreover, although the vehicle 100 includes other sensors 104 (not shown), such as vehicle side sensors (not shown) that face outwardly from the vehicle sides 234, a detection range of each of the other sensors 104 facing lane 216 is at least partially obstructed by vehicle 214. As such, another imperceptible area 239 is defined immediately and obliquely in front of, to the far side of, and obliquely with respect to, vehicle 214.

In such a traffic dense environment, area, or situation 200, and when approaching such a traffic dense environment 200, as the vehicle 100 detects the traffic dense environment 200, the vehicle controller 110 receives data from the sensors 104. Using the data from the sensors 104, the controller 110 determines a type of triggering area 200 that the vehicle 100 is approaching, or is within, and identifies the traffic dense environment 200 using the TC model. In response to a triggering environment 200 being detected, the vehicle controller 110 initially determines that operating condition thresholds for the drone 140 are not exceeded, and then launches the tethered drone 140 airborne ahead of the vehicle 100 to enable a better detection with the LIDAR sensor 108 of the environment 200 that vehicle 100 is traveling through. For example, in one embodiment, the drone 140 may have a vehicle speed limit threshold, such as 70 mph, for example. The vehicle speed limit threshold represents the maximum speed that the vehicle 100 may be traveling with the drone 140 deployed. The drone 140 enables additional data to be collected from a higher/elevated vantage point, ahead of the vehicle 100. The captured data is transmitted continuously to the vehicle controller 100 to enable the vehicle controller 100, through the ES model, to determine one or more courses of action for the vehicle 100 to perform.

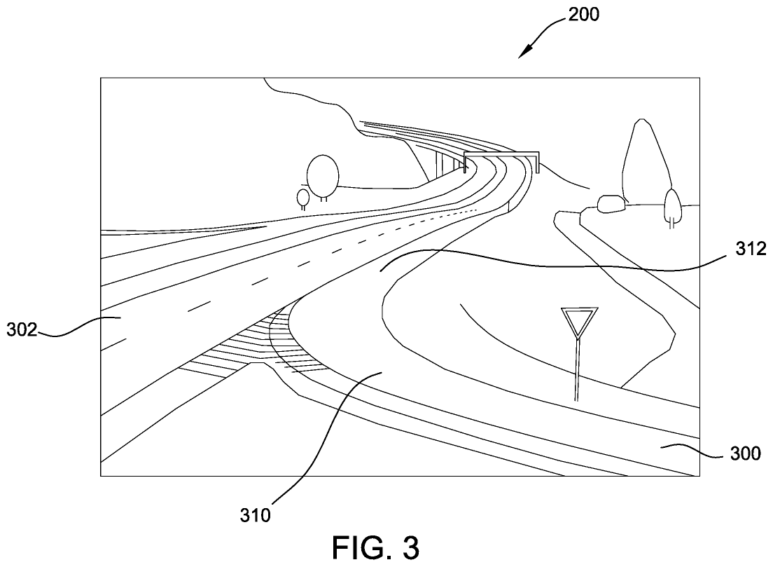

FIG. 3 illustrates a schematic diagram of an on-ramp/merge lane 300 that could be detected as a potential triggering area 200 that should trigger a launch of the drone 140 (shown in FIG. 1) from the vehicle 100 (shown in FIG. 1). In the illustrated embodiment, an on-ramp/merge lane 300 provides access to a multi-lane throughfare 302, such as an interstate highway. As is common with such on-ramps 300, in the exemplary embodiment, the on-ramp 300 provides access to a controlled highway 302 and includes a first section 310 of ramp 300, also known as a hard nose section, that enables a vehicle to accelerate to a speed that is closer to the speed of vehicles already traveling on the highway 302. Typically, the hard nose section 310 of the on-ramp 300 elevates the vehicle from a lower road (not shown) to an elevation that is closer to the elevation of the highway 302 at the access point. The hard nose section, as is common, is not parallel to the highway 302 at the access point, but rather extends into a second section 312 of the on-ramp, also known as soft nose section. The soft nose section 312 of the on-ramp 300 enables a vehicle to maintain its current speed and/or to accelerate to substantially match the speed of other vehicles already traveling on the highway 302, while traveling in a section 312 that is generally parallel to the highway 302. As such, the soft nose section 312 of the ramp 300 provides a vehicle with ample time and distance to enable the vehicle to safely merge onto the highway 302 and into any traffic already traveling on the highway 302.

In such a potential traffic dense environment 200, and when approaching such a traffic dense environment 200, as the vehicle 100 detects it is approaching and entering an on-ramp/merge lane 300, the vehicle controller 110 receives data from the sensors 104. Using the data from the sensors 104, the controller 110 (shown in FIG. 1) determines a type of triggering designation area 200 that the vehicle 100 is approaching, or is within, and identifies the traffic dense environment 200 using the TC model. In response to a triggering environment 200 being detected, the vehicle controller 110 launches the tethered drone 140 airborne ahead of the vehicle 100 to enable a better detection, with the LIDAR sensor 108 (shown in FIG. 1), of the environment 200 that vehicle 100 is approaching. The drone 140 collects additional data from a higher/elevated vantage point ahead of the vehicle 100 and transmits that data continuously to the vehicle controller 100 to enable the vehicle controller 100, through the ES model for example, to determine one or more courses of action for the vehicle 100 to perform. In some embodiments, the TC model is programmed to automatically launch the drone 140 when the vehicle 100 is determined to be a pre-defined distance from the hard nose section 310 of the on-ramp/merge lane 300. The drone 140 will continuously transmit data to the vehicle controller 110 to enable the vehicle 100 to have a smooth transition through the soft nose section of the on-ramp/merge lane 300, onto the highway 302, and into any traffic present on the highway 302.

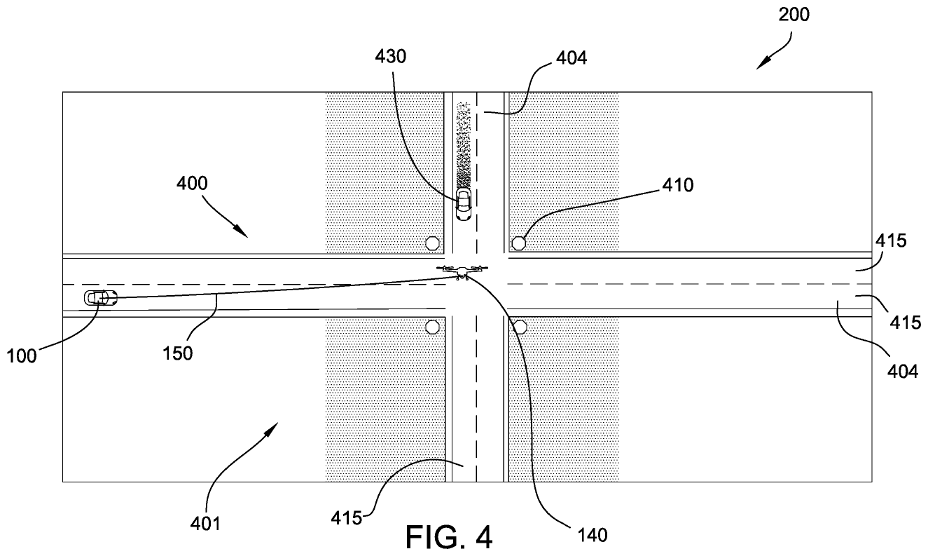

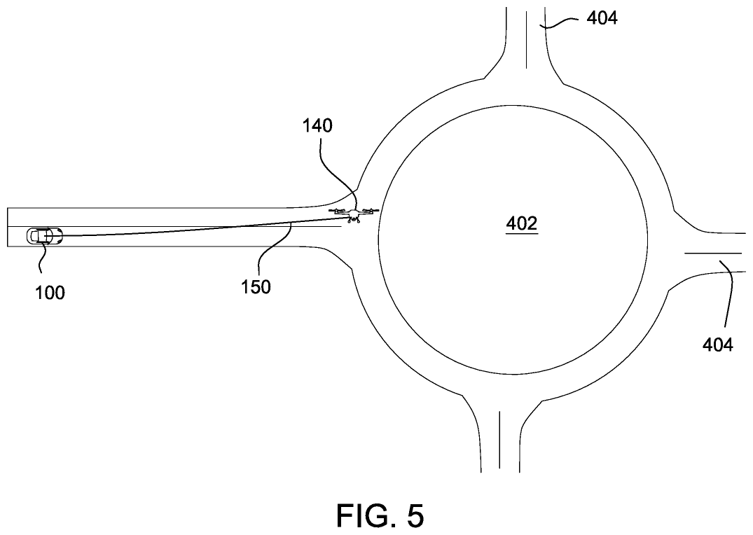

FIG. 4 illustrates a schematic diagram of an intersection 400 that could trigger a launch of the drone 140. FIG. 5 illustrates a schematic diagram of another intersection 400 that could trigger a launch of the drone 140. More specifically, the intersection 400 in FIG. 4 is known as an n-way intersection 401, wherein n is an integer, as explained in more detail below, and the intersection in FIG. 5 is known as a round-about intersection 402. In the exemplary embodiments of FIGS. 4 and 5, one or more roads 404 converge or merge to form the intersections 401 and/or 402. The intersection 400 may or may not include traffic signals 410 (also known as traffic lights 410) designed to assist controlling a flow of traffic for a plurality of lanes 415. Additionally, the intersection 400 may include stop signs (not shown). The plurality of lanes 415 may include left turn lanes, straight lanes, and/or right turn lanes, for example. Each lane 415 may include other vehicles 430 traveling therethrough. For the purposes of this discussion, the other vehicles 430 can include, but are not limited to only including, sedans, sportscars, vans, panel vans, pick-up trucks, buses, trolley cars, public transportation, tractor trailers, 18-wheelers, RVs (recreational vehicle), motorcycles, scooters, bicycles, trailers, emergency vehicles, farm vehicles, oversized vehicles, and/or any other type of vehicle 430. Similarly, intersection 402 is known as a round-about or traffic circle, and it includes four roads 404 that converge to form the intersection 402.

Each intersection type 400 includes one or more triggering areas 200 associated with one or more features and/or configurations associated with the type of intersection type 400. For example, triggering designation areas 200 may be different based on any of the following: a) number of roads merging at the intersection (referred to herein as n-way, where n is an integer number); b) traffic circle; c) number of lanes (referred to herein as m-lanes, wherein m is an integer); d) number of lanes for each of the roads merging at the intersection; e) controlled (e.g., having one or more traffic lights) or uncontrolled (e.g., having no traffic lights); f) controlled or uncontrolled status for each of the roads merging at the intersection; g) merging lanes or no merging lanes; h) pedestrian cross-walk or no pedestrian cross-walk; i) median or no median, j) stop sign or no stop sign; k) yield sign or no yield sign; l) speed limit; m) train-crossing (e.g., locomotion train, passenger train, tram, streetcar, and/or other rail-type transportation) crossing or no train-crossing, n) bus stop or no bus stop, and/or o) traffic data (e.g., heavy traffic, mild traffic, minimal traffic, number of merging vehicles, and/or number of vehicles in a road or a lane). In other embodiments, there may be additional and/or alternative designations 200 that describe additional features of a traffic intersection.

In such a potential traffic dense environment 200, and when approaching such a traffic dense environment 200, as the vehicle 100 detects it is approaching an intersection 400, the vehicle controller 110 receives data from the sensors 104 coupled to the vehicle 100. Using the data from the sensors 104, the controller 110 determines a type of triggering area 200 that the vehicle 100 is approaching, or is within, and identifies the traffic dense environment 200 using the TC model. In response to a triggering environment 200 being detected, the vehicle controller 110 launches the tethered drone 140 airborne ahead of the vehicle 100 to enable a better detection of the intersection 400 using the LIDAR sensor 108. The drone 140 collects additional data from a higher/elevated vantage point ahead of the vehicle 100 and transmits that data continuously to the vehicle controller 100 to enable the vehicle controller 110 to determine one or more courses of action for the vehicle 100 to perform. In some embodiments, the TC model is programmed to automatically launch the drone 140 when the vehicle 100 is determined to be a pre-defined distance from the intersection 400. The drone 140 will continuously transmit data to the vehicle controller 110 to enable a smooth transition through the intersection 400.

Although only two different intersections 401 and 402 are illustrated, the vehicle controller 110 is programmed with a plurality of different intersections 400. For example, the TC model is programmed to automatically launch the drone 140 when the vehicle 100 is a pre-defined distance from an intersection involving a first road having four traffic lanes and a second road having only two traffic lanes 415. Moreover, the vehicle controller is programmed with a plurality of other potential traffic dense environments including, but not limited to, a traffic circle having four roads that each have multiple traffic lanes that merge at the intersection 400, wherein each of the roads 404 includes two traffic lanes 415, a traffic circle having an inner traffic lane and an outer traffic lane, a Y-intersection 400 where three roads 404 converge, and any other common intersection 400.

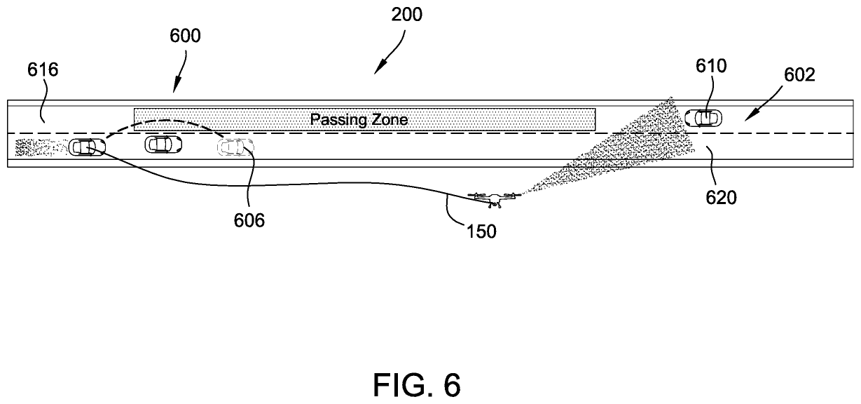

FIG. 6 illustrates a schematic diagram of the vehicle 100 executing a driving maneuver 600 that could be detected as a potential triggering designation area 200 that should trigger a launch of the drone 140 from the vehicle 100. In the illustrated embodiment, vehicle 100 is traveling on a two-lane road 602 and is approaching another vehicle 604 that is traveling in the same direction as vehicle 100. In such an embodiment, as vehicle 100 approaches the vehicle 604 an imperceptible area 606 is defined in front of the vehicle 604. Because a distance between vehicle 100 and vehicle 604 narrows as vehicle 100 travels along road 602, vehicle 100 is traveling at a higher speed than a speed of vehicle 604. More specifically, as vehicle 100 approaches vehicle 604 sensors 106 (shown in FIG. 1) on the vehicle 100, as well as the LIDAR sensor 108 (shown in FIG. 1) on the drone 140 continuously transmit data to the vehicle controller 110 (shown in FIG. 1) to enable the current surroundings and environment of vehicle 100 to be detected.

The ES model and/or the vehicle controller 110 may determine that the course of action for the vehicle 110 should be to pass the vehicle 604 when the space and distance from any oncoming traffic 610 is sufficient to enable vehicle 100 to safely pass vehicle 604. In such an embodiment, the vehicle controller 110 will cause the drone 140 to launch ahead of the vehicle 100 to assist in determining when the vehicle 100 has sufficient space and distance to safely pass the vehicle 604. When it is determined that sufficient space and distance exist to enable the vehicle 604 to be passed by vehicle 100, vehicle 100 will enter the on-coming traffic lane 616, accelerate, will travel past vehicle 604, and using LIDAR data from sensors 108, when return to the initial travel lane of traffic 620 having passed vehicle 604. After passing vehicle 604, the drone 140 will return to vehicle 100, engage the landing dock 142 (shown in FIG. 1), be re-charged as necessary, and will continue to transmit LIDAR data continuously to the vehicle controller 110. In the exemplary embodiment, similar actions may occur should vehicle 110 encounter an obstacle, i.e., an accident, an object in the road, etc., in its path of travel.

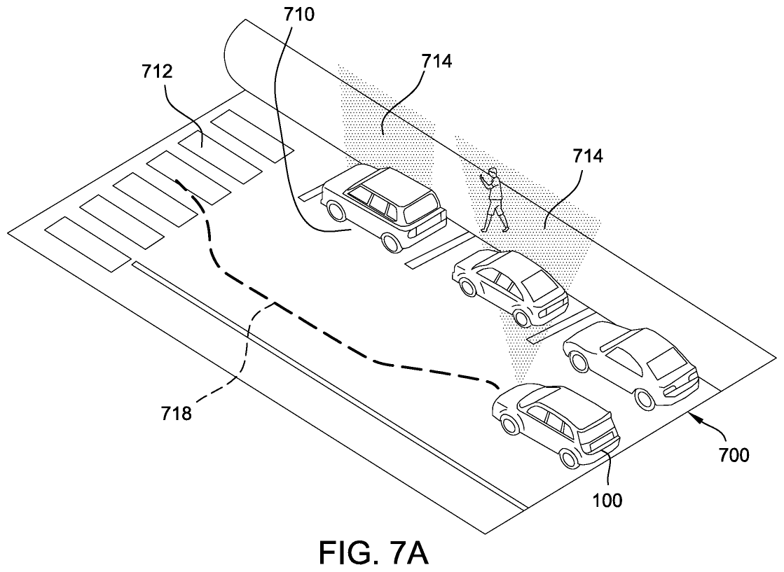

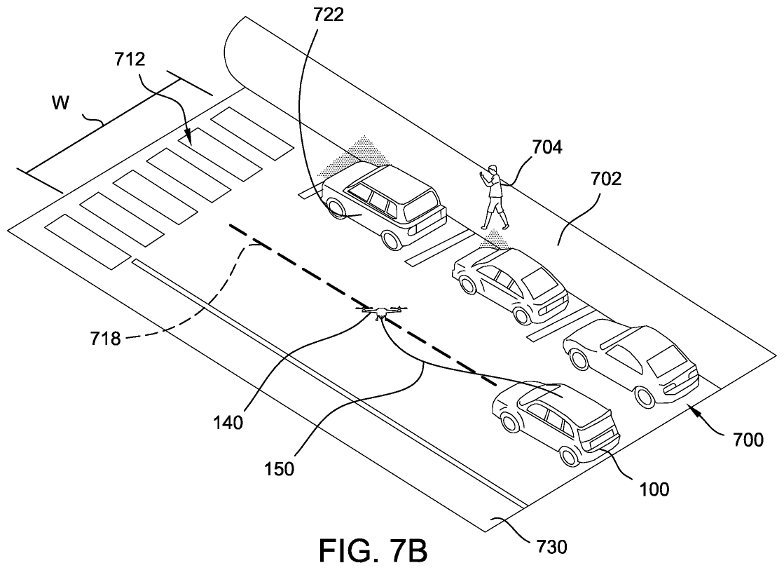

FIG. 7a is a schematic diagram of the vehicle 100 that has not launched a drone 140 and that is traveling within a potential triggering designation environment 200. FIG. 7b is a schematic diagram of the vehicle shown in FIG. 7a and with the drone 140 launched from the vehicle 100 within the potential triggering designation environment 200 shown in FIG. 7a. In the illustrated embodiment, vehicle 100 is traveling within an urban area that includes a row of other vehicles 700 that are stopped adjacent to an area 702 that may be traversed by pedestrians 704, such as a sidewalk, for example. The vehicles may be parked in parking spaces 710, as shown in FIGS. 7a and 7b, or may merely be pulled over along side of the road 712, for example. As best seen in FIG. 7a, as the vehicle 100 approaches and passes the stopped vehicles 700, an imperceptible area 714 is created to the far side of the vehicles 700, i.e., the side of the vehicles 700 closest to the potential pedestrian area 702. As a result, although sensors 104 on the vehicle 100 may detect a pedestrian 704 adjacent to vehicles 700, sensors 104 are generally not capable of continuously monitoring or detecting the motion of the pedestrian 704, or anything else, within the imperceptible area 714.

Accordingly, to compensate for the lack of monitoring within area 714, when the vehicle 100 is in an autonomous or semi-autonomous driving mode, the vehicle controller 110 biases the travel path 718 of the vehicle 100 outwardly and away from the vehicles 700. Biasing the vehicle travel path 718 outwardly, enables the vehicle 100 to provide additional space and timing, in anticipation of a pedestrian 704, or anything else, entering the road 712 between adjacent vehicles 700 to enter a driver's side 722 of a vehicle 700 or to cross the road 712. However, in inner-city and urban driving conditions, it may be difficult to bias the travel path 718 of the vehicle 100 depending on the width W of the road 712, an amount of free space within the triggering area 200, and/or an amount of traffic (not shown) in an adjacent lane of traffic 730 and/or adjacent to road 712, for example. As such, launching the drone 140 as the vehicle 100 approaches an environment 200 in which an imperceptible area 714 is detected enables the drone 140 to launch ahead of the vehicle 100 to assist in monitoring area 714 and to assist in determining if, or when, vehicle 100 should adjust its travel path outwardly away from parked vehicles 700. More specifically, the drone 140 can transmit continuous LIDAR data to the vehicle 100 while vehicle 100 is traveling past vehicles 700 and an area 714 that would ordinarily be imperceptible. After passing vehicles 700, the drone 140 will return to the vehicle 100, engage the landing dock 142, be re-charged as necessary, and will continue to transmit LIDAR data to the vehicle controller 110. In the exemplary embodiment, similar actions may occur should vehicle 110 encounter an obstacle, i.e., a road construction area, an area where a utility vehicle is working on overhead lights, and/or any other area including an obstacle or object in an adjacent path of travel, that creates a potential imperceptible area 714 for vehicle 100.

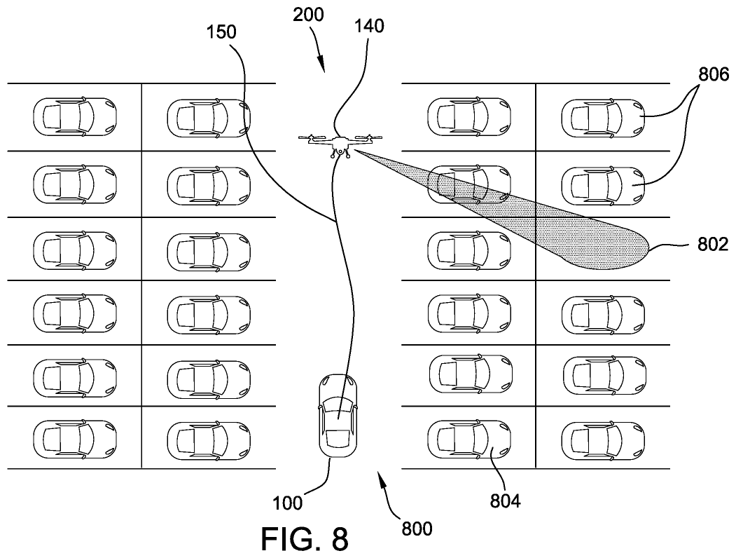

FIG. 8 is a schematic diagram of another environment 200, i.e., a parking lot 800, that could trigger a launch of the drone 140. Specifically, in FIG. 8, the vehicle 100 has entered a parking lot 800 and because of several imperceptible areas (not labeled in FIG. 8), the drone 140 has launched to assist the vehicle controller 110 and/or a driver of the vehicle 100 in determining an appropriate course of action and/or to enable the vehicle to navigate to an empty parking space 802 for example. In the illustrated embodiment, vehicle 100 is traveling within parking area 800 that includes at least one row 804 of other vehicles 806 that occupy parking spaces 802. The parking lot 800 may include pedestrians (not shown) that are walking adjacent to the vehicles 806 and/or within other areas of the parking lot 800. As the vehicle 100 travels between the rows 804 of parked vehicles 806, many imperceptible areas may be created around the vehicle 100. As a result, although sensors 104 on the vehicle 100 may detect parked vehicles 806 adjacent to vehicle 100, sensors 104 are generally not capable of continuously monitoring the entire parking lot 800 in close proximity to the vehicle 100 and/or detecting an empty parking space 802 that is not immediately adjacent to the vehicle, or that may be an imperceptible area relative to the vehicle 100.

Accordingly, when the vehicle 100 enters the parking lot 800 and an imperceptible area is detected, if the vehicle 100 is in an autonomous or semi-autonomous driving mode, the vehicle controller 110 causes the drone to launch ahead and above the vehicle 100 to assist in monitoring area 200. More specifically, the drone 140 can transmit continuous LIDAR data to the vehicle 100 while vehicle 100 is traveling past vehicles 806 and past areas that would ordinarily be imperceptible. After passing vehicles 806, the drone 140 will return to the vehicle 100, engage the landing dock 142 (shown in FIG. 1), be re-charged as necessary, and will continue to transmit LIDAR data to the vehicle controller 110. In other embodiments, the drone 140 can detect any empty parking spaces 802 in the area surrounding the vehicle 100 and the controller can determine a travel path to an identified empty parking space 802. In the exemplary embodiment, the drone sensors 108 continuously monitor the parking lot 800 as the vehicle 100 travels through it, as well as the environment immediately surrounding the vehicle 100. More specifically, the LIDAR sensors mounted to the drone 140 are capable of continuously collecting data used to generate a 3D map as the vehicle 100 travels through the parking lot 800.

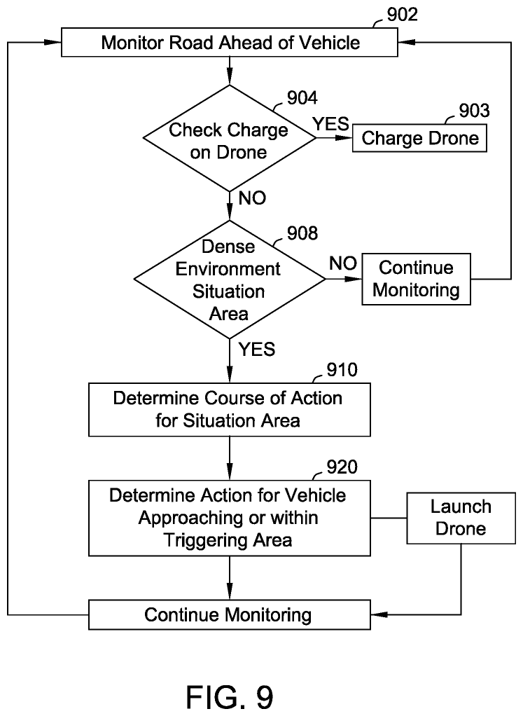

FIG. 9 illustrates a flowchart of an exemplary process 900 that may be implemented to determine one or more courses of action for a vehicle, such as vehicle 100 (shown in FIG. 1) to perform when approaching a traffic dense environment, such as a potential dense traffic environment 200 (shown in FIGS. 2-8, for example). Exemplary courses of action may include, but are not limited to only including, steering, accelerating/decelerating, moving into a different travel lane, moving/shifting a position of the vehicle 100 within a traffic lane, choosing an intersection path for a vehicle at an intersection, and/or identifying a parking space to enter. In the exemplary embodiment, process 900 is implemented by the vehicle controller 110 (shown in FIG. 1) in the user's vehicle 100. In other embodiments, portions of process 900 are performed by the vehicle controller 110 and other portions of the process may be performed by one or more remote servers. In each embodiment, as described herein, processing is not performed within or at the drone, but rather, in contrast, processing is performed at the vehicle controller and/or at a remote server using LIDAR data transmitted from the drone in combination with data obtained from other sensors on-board the vehicle. In each embodiment, the combination of the LIDAR data and data from other sensors on-board the vehicle is used to create a three-dimensional (3D) map in real-time.

The vehicle controller 100 monitors 902 the road ahead of the vehicle 100. Monitoring 902 may include the vehicle controller 110 receiving sensor data from at least one sensor 106 on-board the vehicle 100, as well as LIDAR data from at least one sensor 108 coupled to the drone 140 while the drone 140 is securely coupled within the vehicle landing dock 142. While in the loading dock 142, the vehicle controller also determines 904 whether the drone 140 requires charging 903, and if so, supplies electric current to the drone 140 through either the tether or through the loading dock 142 to charge the drone 140.

The process 900 includes determining 908 whether the vehicle 100 is approaching a traffic dense environment or situation area 200. A pre-defined triggering area 200 includes any designated area or areas that are potential traffic dense areas and/or any other area, such as a parking lot, that may or should create a triggering event causing the drone 140 to launch from the vehicle 100. For example, triggering designation areas 200 may be a type of intersection that the vehicle is approaching, and the type of intersection may be based on the number of roads that merge at the intersection and/or the angle at which the roads merge relative to each other. Triggering designation areas 200 may also be based on the number of lanes of traffic and/or a number or volume of vehicles within those lanes, and/or whether designated turning lanes are available. Additional triggering designation areas may arise as the vehicle approaches an on-ramp, approaches three-way or four-way intersections, and/or approaches a round-about. Further triggering events or situations 200 may occur as the controller determines that the vehicle should enter the on-going traffic lane to pass another vehicle traveling in the same direction. Additional triggering designation areas 200 may occur when the vehicle enters a parking lot, and/or is passing a plurality of vehicles stopped or parked adjacent to a parallel sidewalk, for example.

If the vehicle controller 110 determines 908 the vehicle 100 is approaching a triggering area 200, the controller then utilizes at least two process models to determine 910 a course of action for the vehicle 100. In some embodiments, the vehicle controller executes an algorithm to determine 912 whether to launch the drone 140 airborne, and/or which if any course of action should be taken for the vehicle. For example, in the exemplary embodiment, a first process model includes a triggering classification (TC) model that is used to determine the type of triggering event, and a second model includes an environment specific(ES) model that is used to determine one or more courses of action for the vehicle to perform. In some embodiments, the vehicle controller may include a single TC model and a plurality of ES models. Each of the ES models may be associated with a specific type or category of triggering designation areas or environments.

In one embodiment, one or more TC model inputs may be applied to the TC model to determine one or more TC model outputs. Likewise, one or more ES model inputs may be applied to the ES model to determine one or more ES model outputs. The TC model outputs include a determined triggering environment type. The ES model outputs include determining 910 one or more courses of action for the vehicle 100 to perform while entering, approaching, or while within, the triggering designation area 200. The TC model inputs and the ES model inputs may include sensor data collected from one or more of the sensors. The one or more of the TC model inputs may be the same as one or more of the ES model inputs. In some embodiments, one or more of the TC model inputs and the ES model inputs may be different. In some embodiments, the TC model inputs are less than, and/or a subset of the ES model inputs.

In some embodiments, the TC model inputs may include image data collected from sensors, such as video devices, imaging devices, and/or a camera. In other embodiments, the TC model inputs may include additional and/or alternative inputs. In some embodiments, the ES model inputs may include data collected from sensors, such as radar, LIDAR, proximity sensors, ultrasonic sensors, electromagnetic sensors, wide RADAR, long distance RADAR, Global Positioning System (GPS), video devices, imaging devices, cameras, audio recorders, and computer vision.

In the exemplary embodiment, the vehicle controller, initially, in determining 908 a type of triggering designation area that the vehicle 100 is approaching, determines the type of approaching environment, using the TC model, and then subsequently, determines 920 one or more vehicle courses of action for the vehicle to perform using the IS model corresponding to the previously identified type of triggering designation area. In other words, the vehicle controller 110 applies TC model inputs to the TC model initially to determine 908 the type of triggering designation area. After the type of triggering event 200 is identified, the vehicle controller 110 may launch the drone and retrieve, e.g., from a database and/or a memory, an ES model associated with the identified triggering designation. The vehicle controller 110 then applies the ES inputs to the ES model to determine 910 one or more courses of action for the vehicle to perform 920 while approaching and/or within the triggering designation 200.

In some embodiments, after the type of triggering event 200 is identified, the vehicle controller determines whether the speed of the vehicle 100 is below a pre-defined threshold. For example, in some embodiments, the drone 140 will only launch if the vehicle 100 is traveling less than 70 mph, for example.

Determining 908 a type of an approaching triggering area 200 may include applying the sensor data to a model, e.g., IC model, to determine the intersection type. In some embodiments, the vehicle controller 110 may receive the triggering area 200 from a map service (e.g., google maps, maps, etc.) and/or any other suitable source. Process 900 may further include monitoring 902 the road ahead of the user's vehicle by receiving sensor data from the second sensors 108 coupled to the airborne drone 140, as well as data from sensors 106 mounted to the vehicle.

After determining 908 the type of triggering area 200, process 900 determines 910 one or more courses of action for the vehicle 100 to perform 930 at the triggering area 200. Determining 910 a course(s) of action for the vehicle 100 to perform may include retrieving, from a memory and/or a database, an IS model associated with the determined 908 intersection type. For example, if the vehicle controller 110 determined 908 that the vehicle 100 is approaching a merge lane 300, then the vehicle controller 110 retrieves an IS model associated with merge lane e.g., IS-Type A model, and applies either, or both, of the first sensor and second sensor data, to the IS model to determine 910 one or more courses of action for the vehicle to perform 930.

In the exemplary embodiment, the vehicle controller 110 is a processor that controls one or more aspects of the operation of a vehicle 100. A user's vehicle controller 110 may be communicatively coupled through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and/or a cable modem.

In other embodiments, the vehicle is in communication with an infrastructure device to receive traffic information in real-time or near real-time. In some embodiments, the infrastructure device is associated with one or more sensors positioned in proximity to pre-defined triggering areas 200, such as intersections. In further embodiments, the infrastructure device may provide images from one or more cameras at the intersection. In still further embodiments, the infrastructure device may wirelessly broadcast information to all vehicles in the nearby area, such as through Wi-Fi, Bluetooth, and/or ZigBee communications. In some embodiments, the infrastructure device can also include a mapping program server or other program to assist with navigating the vehicle 100. In yet other embodiments, the infrastructure device is in communication with emergency vehicles in the area to enable the vehicle 100 to choose a course of action that provides space to the emergency vehicles to enable the vehicles to pass the vehicle 100 safely, for example.

A database server may be communicatively coupled to a database that stores data. In one embodiment, the database may include types of pre-defined triggering areas 200. In the exemplary embodiment, the database may be stored internally within and/or remotely from the vehicle controller 110. In some embodiments, the database may be decentralized. In some embodiments, the database may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

In some embodiments, the vehicle controller 100 may present information to a user via any component capable of conveying information to the user. In some embodiments, the vehicle controller may be in communication with an an output adapter (not shown) such as a video adapter and/or an audio adapter. An output adapter may be operatively coupled to vehicle controller and/or to an output device such as a display device (e.g., a cathode ray tube (CRT), liquid crystal display (LCD), light emitting diode (LED) display, or “electronic ink” display) or an audio output device (e.g., a speaker or headphones). In some embodiments, the vehicle controller may be configured to present a graphical user interface (e.g., a web browser and/or a client application) to the user, such as through an infotainment panel. A graphical user interface may include, for example, route information. In some embodiments, the user may enter information into the vehicle controller using an input device, such as, without limitation, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 715 and input device 720.

A processor within the vehicle controller executes computer-executable instructions for implementing aspects of the disclosure. In some embodiments, the processor is transformed into a special purpose microprocessor by executing computer-executable instructions or by otherwise being programmed. For example, the processor may be programmed with instructions. The processor may also be operatively coupled to a storage device. The storage device may be any computer-operated hardware suitable for storing and/or retrieving data, such as, but not limited to, data associated with the database. In some embodiments, the storage device is integrated in a server computer device. For example, the server computer device may include one or more hard disk drives as storage device. In other embodiments, the storage device is external to the vehicle 100.

In some additional embodiments, the vehicle controller 110 receives a third plurality of sensor information from one or more infrastructure-based sensors (not shown) positioned in proximity to the approaching intersection.

For the methods described above, the wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally, or alternatively, the autonomous or semi-autonomous technology or functionality may include and/or be related to: driver alertness or responsive monitoring; pedestrian detection; artificial intelligence and/or back-up systems; navigation or GPS-related systems; security and/or anti-hacking measures; and/or theft prevention systems.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on vehicles, stations, nodes, or mobile devices, or associated with smart infrastructures and/or remote servers), and/or through implementation of computer-executable instructions stored on non-transitory computer-readable media or medium. Unless described herein to the contrary, the various steps of the several processes may be performed in a different order, or simultaneously in some instances.

Additionally, the computer systems discussed herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/sub-steps, and store collected data (e.g., vehicle profiles, etc.) in a memory or storage associated therewith. This stored information may be used by the respective processing elements to make the determinations necessary to perform other relevant processing steps, as described above.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

The exemplary systems and methods described and illustrated herein therefore significantly increase the safety of operation of autonomous and semi-autonomous vehicles by reducing the risks associated with such a vehicle approaching a traffic dense environment and by reducing the likelihood of potential risks within the vehicle's surroundings.

The present systems and methods are further advantageous over conventional techniques the embodiments herein are not confined to a single type of vehicle and/or situation but may instead allow for versatile operation within multiple different types of vehicles, including ground craft, watercraft, aircraft, and spacecraft. Accordingly, these novel techniques are of particular value to vehicle manufacturers who desire to have these methods and systems available for the users of their vehicles.

Exemplary embodiments of systems and methods for securely navigating intersections are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computer devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A vehicle comprising:
an integrated advanced driver-assistance system (ADAS) vehicle controller comprising a memory configured to store program instructions, and a processor configured to execute the program instructions;
a plurality of sensors comprising at least a first sensor configured to transmit data to said vehicle controller; and
a drone removably coupled to said vehicle, said drone comprising at least a second sensor configured to transmit data to said processor, said vehicle controller programmed to:
determine whether to launch said drone from said vehicle when said vehicle approaches a pre-defined operating environment; and
selectively change operation of the vehicle based on data received from said drone.

2. The vehicle of claim 1, wherein said vehicle controller is further programmed to:
collect LIDAR data from said drone second sensor while the drone is physically coupled to said vehicle;
collect LIDAR data from said drone second sensor when the drone is airborne;
apply the LIDAR data to a mapping model to generate a real-time map; and
selectively change operation of the vehicle at least partially based on the LIDAR data.

3. The vehicle of claim 2, wherein the first sensor includes at least one of a radar, a video device, an imaging device, and a camera.

4. The vehicle of claim 2, wherein said drone further comprises at least one of a radar, a proximity sensor, an ultrasonic sensor, an electromagnetic sensor, a wide RADAR, a long-distance RADAR, a Global Positioning System (GPS), a video device, an imaging device, a camera, an audio recorder, and a computer vision.

5. The vehicle of claim 2, wherein said drone includes at least one battery configured to power operation of said drone, said vehicle controller is further programmed to determine to charge the at least one battery on said drone while said drone is physically coupled to the vehicle and the vehicle is operating.

6. The vehicle of claim 2, wherein the vehicle controller is further programmed to launch said drone from said vehicle when said vehicle approaches at least one of a hard nose of an on ramp, and a pre-defined intersection classification.

7. The vehicle of claim 2, wherein the vehicle controller is further programmed to launch said drone from said vehicle when a determination is made to pass another vehicle traveling in the same direction.

8. The vehicle of claim 2, wherein the vehicle controller is further programmed to launch said drone from said vehicle when said vehicle at least one of enters a parking lot, and is traveling past a plurality of vehicles stopped adjacent to a sidewalk.

9. A control system for controlling a vehicle, wherein the control system comprises:
a computer device integrated with a vehicle advanced driver-assistance system (ADAS) for the vehicle, wherein the computer device comprises:
at least one memory; and
at least one processor in communication with the at least one memory, the at least one processor programmed to:
collect LIDAR data from at least one drone coupled against the vehicle during operation of the vehicle;
collect LIDAR data from the at least one drone while the drone is airborne and tethered to the vehicle; and
determine at least one course of action for the vehicle to execute, based on the LIDAR data received.

10. The control system of claim 9, wherein the at least one processor is further programmed to:
determine whether the vehicle is approaching a pre-defined operating environment; and
determine whether to launch the at least one drone from the vehicle based on the determination of whether the vehicle is approaching a pre-defined operating environment.

11. The control system of claim 9, wherein the at least one processor further programmed to:
collect operating data from at least one sensor coupled to the vehicle; and
apply the LIDAR data and the data collected from the at least one sensor coupled to the vehicle, to a mapping model to generate a real-time map.

12. The control system of claim 9, wherein the drone is battery-operated, said at least one processor further programmed to charge the batteries on the drone while the vehicle is operating and while the drone is coupled against the vehicle.

13. The control system of claim 9, wherein the at least one processor is further programmed to determine if the vehicle is at least one of approaching a hard nose of an on ramp, approaching a pre-defined intersection classification, entering a parking lot, is preparing to pass another vehicle traveling in the same direction, and is traveling past a plurality of vehicles stopped adjacent to a sidewalk.

14. A method for controlling a vehicle using a vehicle controller associated with the vehicle, the method comprising:
collecting first sensor information from at least a first sensor during operation of the vehicle, wherein the first sensor is coupled to the vehicle;
determining an operating environment of the vehicle based the first sensor information;
determining whether to launch a drone from the vehicle based on the first sensor information;
collecting second sensor data from the drone when the drone is coupled against the vehicle and when the drone is airborne while tethered to the vehicle; and
generate a real-time map based on the collected second sensor data.

15. The method of claim 14 further comprising determining at least one course of action for the vehicle based on the second sensor data collected.

16. The method of claim 14, wherein the drone is battery-powered, said method further comprising charging the batteries on the drone while the vehicle is operating and while the drone is coupled against the vehicle.

17. The method of claim 14, wherein determining an operating condition of the vehicle further comprises determining if the vehicle is at least one of approaching a hard nose of an on ramp, approaching a pre-defined intersection classification, entering a parking lot, is preparing to pass another vehicle traveling in the same direction, and is traveling past a plurality of vehicles stopped adjacent to a sidewalk.

18. The method of claim 17 further comprising launching the drone from the vehicle based on the determination of a current operating environment of the vehicle.

19. The method of claim 17 further comprising receiving an input from a user to launch the drone from the vehicle.

20. The method of claim 17 further comprising:
determining whether an emergency response vehicle is approaching; and
determining at least one course of action based on a determination that an emergency response vehicle is approaching.
